(19) United States
(12) Patent Application Publication
(10) Pub. No.: US 2026/0105322 A1
(43) Pub. Date: Apr. 16, 2026

(54) SYSTEM AND METHOD FOR ENHANCING COMPUTATIONAL CONSISTENCY BETWEEN DISPARATE COMPUTING SYSTEMS

(71) Applicant: QPQ Ltd., Dublin 2 (IE)

(72) Inventors: Greg CHEW, Dublin 2 (IE); Emanuele RAGNOLI, Dublin 2 (IE); Gokhan SAGIRLAR, Dublin 2 (IE)

(73) Assignee: QPQ Ltd., Dublin 2 (IE)

(21) Appl. No.: 19/116,740

(22) PCT Filed: Oct. 19, 2022
(86) PCT No.: PCT/EP2022/079138

§ 371 Date: Mar. 28, 2025

(51) Int. Cl. G06N 5/022; G06N 7/01

(52) U.S. Cl. CPC G06N 5/022; G06N 7/01

(57) ABSTRACT

A method and system for enhancing computational consistency between a distributed ledger and a semantic database in which a semantic database probability landscape representing expected state changes associated with the execution of a digital protocol and a distributed ledger and a distributed ledge probability landscape representing actual execution results of the digital protocol on the distributed ledger are iteratively varied to arrive at mutually consistent data and information sets. Weightings are returned to the semantic database and a revised digital protocol is returned to the distributed ledger for execution, both of which are derived from the mutually consistent data and information set. A processor and system arranged to provide communication between the distributed ledger and the semantic database are also disclosed.

### FIELD OF THE DISCLOSURE

The present disclosure relates to a system and method for enhancing computational consistency between disparate computing systems. More particularly, but not exclusively, it relates to a system and method for enhancing computational consistency between a distributed ledger and a semantic database. Even more particularly, but not exclusively, it relates to a system and method for enhancing computational consistency between a DLT and a knowledge graph database.

### BACKGROUND TO THE DISCLOSURE

Semantic databases, for example knowledge graph databases (KG), and consensus protocol driven distributed systems, exemplified by distributed ledger technology (DLT) use nodes, to persist, replicate, represent and manage their networked data structures. In the case of DLT, these nodes are by definition distributed across a network, whilst in the case of KG they can be distributed across a network or can be in a single data store.

A KG is a graph of data comprising nodes that convey knowledge of entities and links between those nodes, known as edges convey the relationship between nodes. relationships between those entities. The nature of a KG means that it contains varying amounts of data related to each entity, meta-data, and the strength, weighting, or other characteristic of the relationship between each node can be different, and is often represented by relative weightings. This makes KGs much more useful for deriving insights than, for example a relational database where strict data schema are enforced.

In a DLT system an immutable record of a result of any data processing event is stored in at the nodes of the ledger. However, the nodes of the DLT must achieve a consensus that there is a single outcome of the data processing event and to that end consensus protocols are used to arrive at an agreement on a data value derived independently at each of the nodes of the DLT. This ensures that transaction processing and transaction history exhibited and embedded in the DLT is internally consistent across each node of the DLT, such that whichever node is queried the same data is output. Once a data processing event result is stored on the DL it is stored as a discrete piece of data, without context, across the nodes of the DL.

The distinct natures of the respective data formats stored in a KG and DLT are a problem in providing communication between KSs and DLTs such that they can be integrated into a single system providing the capability of providing insights of a KG along with the immutable storage and security of a DLT. Furthermore, there is currently no efficient way to update a KG's graph structure with DLT execution data nor can the insights from a KG be easily used to provide inputs to the DLT consensus mechanism. Thus, computational consistency between, and integration, of KGs and DLTs is a problem due their distinct data formats and data content which can limit interoperability between a Turing machine for example, by way of non-limiting example, a DLT and a non-Turing system for example, by way of non-limiting example a KG. This therefore restricts the ability of computing systems comprising, by way of non-limiting example, KGs and DLTs from performing cross-platform recursive operations efficiently.

### SUMMARY OF THE DISCLOSURE

According to a first aspect of the present disclosure there is provided a method of enhancing computational consistency between a distributed ledger and a semantic database comprising:
i) generating a semantic database probability landscape of state changes based upon the probability of possible execution results of operations within the semantic database;
ii) generating a distributed ledger probability landscape based upon results of execution of a digital protocol;
iii) determining differences between respective points of the semantic database probability landscape and the distributed ledger probability landscape;
iv) executing operations on at least one of the semantic database probability landscape and the distributed ledger probability landscape if the difference at at least one of the points exceeds a threshold;
v) iterating steps vi) and vii) until none of the differences between respective points of the semantic database probability landscape and the distributed ledger probability landscape exceeds the threshold;
vi) determining state transition values for the semantic database associated with a final state wherein none of the differences between at least one pair of respective points of the semantic database probability landscape and the distributed ledger probability landscape exceeds the threshold; and
vii) transmit the state transition values to the semantic database.

The convergence of respective outcome probability landscapes associated with the DLT and the semantic database provides a means of operably communicating between the disparate data structures of a DLT and a semantic databases by allowing state transitions. State values associated with congruent outcomes that can be used to generate a complex digital protocol dictionary that can be fed back to the semantic database for execution to continue logical processing of data within the semantic database by automatically updating the semantic database with data corresponding to the actual outcomes on the DLT.

The semantic database may comprise a knowledge graph. The method may comprise generating the semantic database probability landscape may comprise analysing a plurality of execution results of a plurality of operations within the knowledge graph. The method may comprise generating the semantic database probability landscape may comprise verifying the plurality of execution results of the plurality of operations. The method may comprise generating the semantic probability landscape may comprise querying nodes of the knowledge graph and identifying nodes within the knowledge graph at which the plurality of execution results is located. The method may comprise generating the semantic database probability landscape may comprise assigning a respective weight to the plurality of execution results based upon the node at which the plurality of execution results is located. The method may comprise generating the semantic database probability landscape may comprise mapping the plurality of execution results as state changes effected by the operations. The method may comprise generating the semantic database probability landscape may comprise weighting state changes using the weights assigned to the plurality of execution results. The method may comprise assigning a probability to each of the plurality of execution results.

The method may comprise comparing execution results of the digital protocol upon the distributed ledger to a library of expected results and generating an exception list corresponding to divergences between the library of expected results and the execution results. The method may comprise generating the distributed ledger probability landscape based upon the exception list. The method may comprise excluding expected execution results from the generation of the distributed ledger probability landscape.

The method may comprise aligning respective events in the semantic database probability landscape and the distributed ledger. Determining differences between respective points of the semantic database probability landscape and the distributed ledger probability landscape may comprise calculating probability difference vectors between the respective points and determining the magnitude of respective probability difference vectors.

The method may comprise generating an updated digital protocol dictionary comprising state transition values corresponding to a state where the probability difference vectors are below the predetermined threshold. The updated digital protocol dictionary may comprise metadata associated with possible execution results of operations in the updated digital protocol library.

Either or both of the semantic database probability landscape or/and the distributed ledger probability landscape may comprise an n-dimensional hyperplane.

The difference between respective points of the semantic database probability landscape or/and the distributed ledger probability landscape may be determined using a generalised norm technique. The general norm technique may at least one of the following: Euclidian Distance, Mahattan Distance, p-norm.

The method may comprise generating possible execution results of defined operations on the semantic database.

The method may comprise generating a digital protocol comprising instructions based upon possible execution results of the operations. The method may comprise executing the digital protocol at nodes of a distributed ledger. The digital protocol may comprise a machine readable text.

According to a second aspect of the present disclosure there is provided a processor arranged to:
generate possible execution results of defined operations on an semantic database;
generate an semantic database probability landscape of state changes based upon a probability of the possible execution results;
generate a distributed ledger probability landscape based upon results of execution of a digital protocol on the distributed ledger;
determine differences between respective points of the semantic database probability landscape and the distributed ledger probability landscape;
execute operations on at least one of the semantic database probability landscape and the distributed ledger probability landscape if the difference at at least one of the points exceeds a threshold;
iterate steps vi) and vii) until none of the differences between respective points of the semantic database probability landscape and the distributed ledger probability landscape exceeds the threshold;
determine state transition values for the semantic database associated with a final state wherein none of the differences between at least one pair of respective points of the semantic database probability landscape and the distributed ledger probability landscape exceeds the threshold; and
output the state transition values to the semantic database.

The, or a second, processor may be update the semantic database in response to receiving the state transition values.

The, or a second processor, may be arranged to generate possible execution results of defined operations on the semantic database. The, or a second processor, may be arranged to generate a digital protocol comprising instructions based upon possible execution results of the operations. The, or a second processor may be arranged to weight the possible execution results of the operations prior to generating the digital protocol.

According to a third aspect of the present invention there is provided a computing system comprising:
a distributed ledger comprising a plurality of nodes;
a semantic database;
a processor arranged to operate according to the second aspect of the present disclosure.

According to a fourth aspect of the present invention there is provided a digital protocol adapter arranged to:
receive a digital protocol for execution on nodes of a distributed ledger;
determine if the digital protocol differs from an existing digital protocol executing on the nodes of the distributed ledger;
interrupt the execution of the existing digital protocol on the nodes of the distributed ledger if the digital protocol differs from the existing digital protocol;
upload the digital protocol to the nodes of the distributed ledger if the digital protocol differs from the existing digital protocol; and
instruct the nodes of the distributed ledger to initiate applying the digital protocol.

According to fifth aspect of the present disclosure there is provided an event regulator arranged to:
receive at least one of the following data from a distributed ledger: execution data, performance data;
analyse the at least one data to determine exceptions corresponding to divergences between a library of expected results and the at least one data;
generate an exception list corresponding to divergences between the library of expected results and the at least one data;
output the exception list to a decision module.

The event regulator may be arranged to receive data weighting parameters. The event regulator may be arranged to apply the data weighting parameters to the at least one data to generate weighted data. The event regulator may be arranged to analyse the weighted data to determine the divergences.

### BRIEF DESCRIPTION OF THE DRAWINGS

The disclosure will now be described, by way of example only, with reference to the accompanying drawings in which:

FIG. 1 is a schematic representation of a computing system according an aspect of the present disclosure comprising a processor according to a further aspect of the present disclosure;

FIG. 2 is a schematic representation of an architecture comprising a data translation system according to an aspect of the present disclosure;

FIG. 3 is schematic representation of the semantic interaction between a distributed ledger and a knowledge graph via a decision module according to an aspect of the present disclosure;

FIG. 4 is a schematic representation of the interaction at the physical layer between graph nodes of a knowledge graph and digital protocol execution nodes of a distributed ledger according to an aspect of the present disclosure;

FIG. 5 is a schematic representation of n-dimensional hyperplanes corresponding to probability landscapes of a semantic database probability landscape and a distributed ledger probability landscape, showing a probability difference vector between respective points thereof; and

FIG. 6 is flowchart showing a method of providing computational consistency between a distributed ledger and a semantic database.

### DETAILED DESCRIPTION OF EXEMPLARY EMBODIMENTS

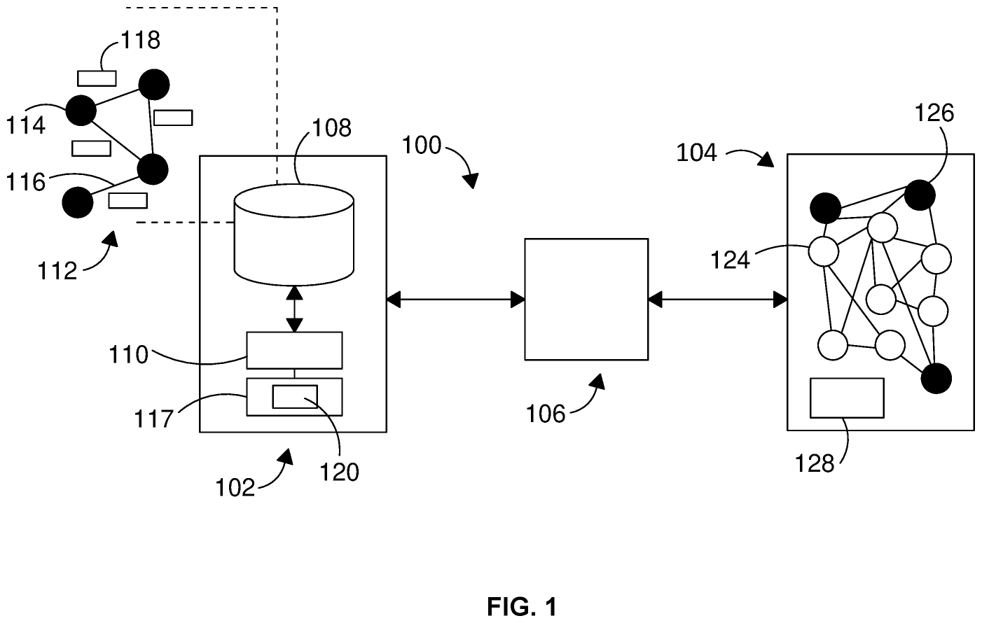

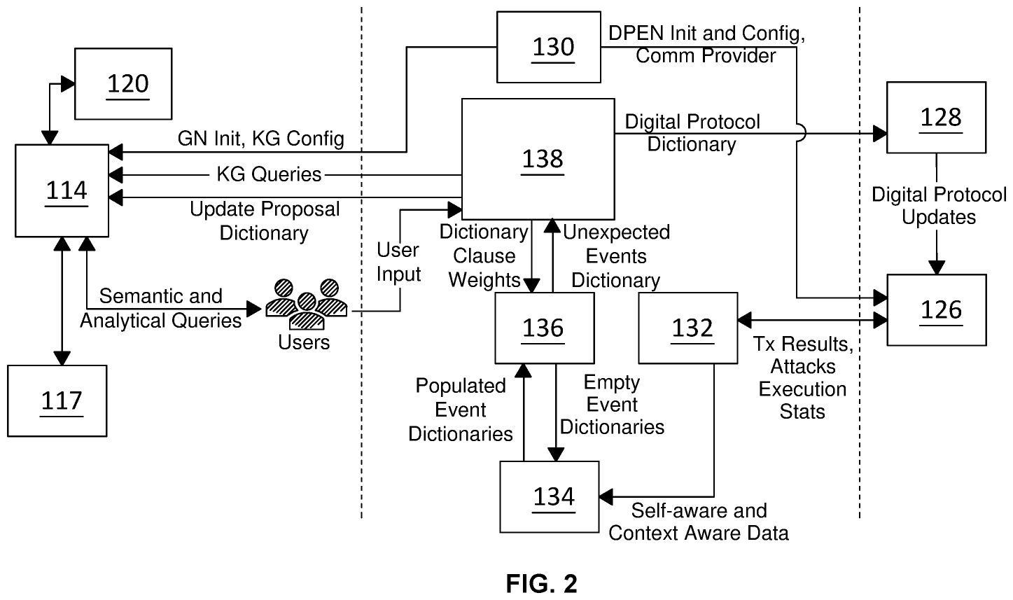

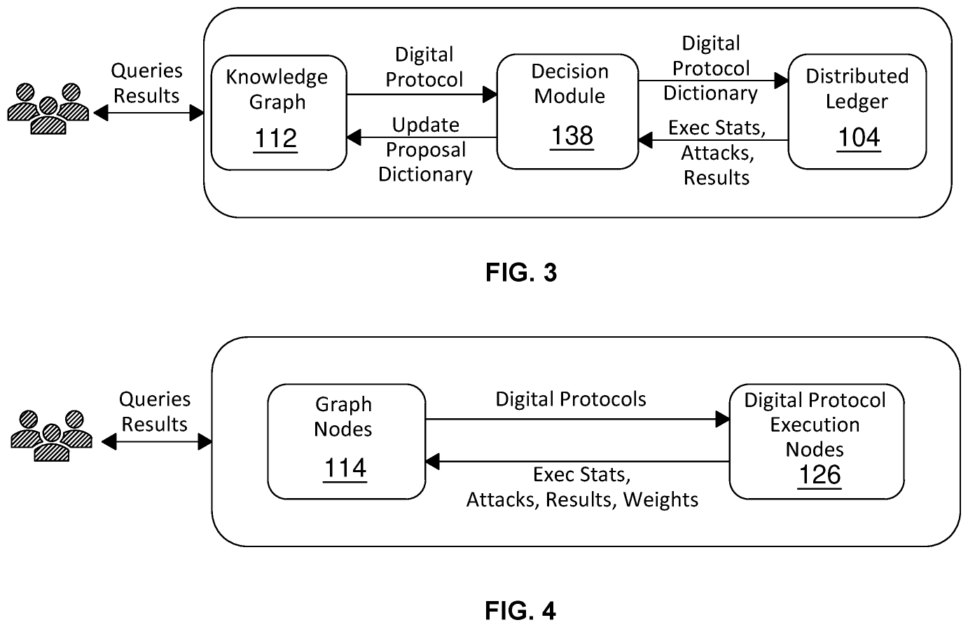

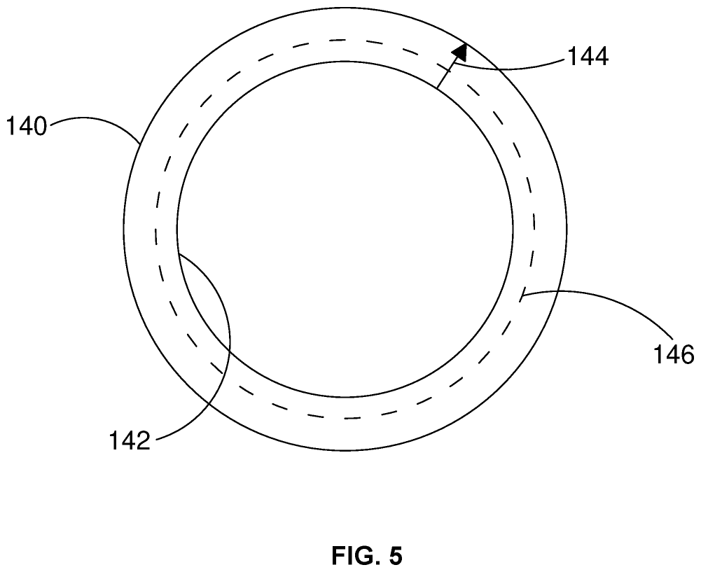

Referring now to FIGS. 1 and 2, a computing system 100 comprises a semantic database system 102, a distributed ledger (DL) 104 and a communication unit 106.

The semantic database system 102 comprises a storage device 108 and a processor 110. The storage device 108 stores a copy of a semantic database, typically but not exclusively, a knowledge graph 112 and the processor 110 is arranged to perform operations upon the knowledge graph 112. It will be appreciated that there may be a plurality of storage devices, each storing either a full or partial copy of the knowledge graph and there may be a plurality of processors.

The knowledge graph 112 comprises nodes 114, edges 116, labels 118 associated with the edges 116 and a graph query tool 117. The nodes 114 represent, for example objects, events, situations or abstract concepts, the edges 116 representing the relationships between the nodes 114 and the labels 118 detail the semantics, nature of the relationships, associated with the edges 116. For example, the labels 118 comprise metadata describing relationships in terms of, by way of non-limiting example, classification, ontology, dependencies with other operative statements, historical information, and the like.

The graph nodes 114 comprise a graph data store 120, typically as a submodule of the graph nodes 114. The graph data store 120 persists maintains the knowledge graph 112 by processing graph configuration updates received at the graph nodes 114 such that an updated graph data structure is output to the graph nodes 114 which migrate the updated configuration to their local data graph. These configuration updates typically relate to the addition or deletion of graph nodes 114 and/or edges 116, or the updating of weighting associated with edges 116.

The graph query tool 117 comprises a semantic search query generation logic (SSQGL) engine 122 configured to convert the input data provided by the user into a semantic search query comprising a plurality of search criteria for retrieving for example data, metadata or operative statements the KG 112. Typically, the graph query tool 117 comprises libraries and respective graph query languages, such as, by way on non-limiting example, SPARQL, GQL, Cypher, Gremlin, GraphQL, associated with different types of graph data models. The graph query tool 117 is arranged to perform analytics and information retrieval and derivation queries submitted by a user via respective interfaces associated with the graph data store 120 or the graph nodes 114, the user queries typically, but not exclusively, being in the form of plain text queries.

The distributed ledger 104 comprises a series of DL nodes 124, at least some of which are digital protocol execution nodes (DPEN) 126 and a digital protocol adapter (DPA) 128. It will be appreciated that although shown as spatially separate entities the DL nodes 124, DPENs 126 and DPA 128 may be executed at the same physical entity, i.e. the same location but may be running on separate processors or may be logically separated.

The DL nodes 124 are replicated, shared, and synchronized stores of data which is typically validated via a consensus algorithm to provide a trusted repository of data records that are typically considered to be immutable. Ledger updates corresponding to a state change within the DL 104 occur when for example a transaction or an update to the KG 112 occurs and the nodes 124 construct new states in response a transaction or update to the KG 112 via digital protocols generated by the KG 112. It will be appreciated that an update to the DL 104 may simply be a new executed transaction, such as get_value(field_name) and as such not all ledger update triggers a change in KG 112. Even if there is a ledger update transaction that triggers an update to the KG 112 update, whether a new protocol is generated by DPA 128, depends on whether the degree of change to the KG 112 passes a threshold.

The DPENs 126 are those nodes which take part in the consensus protocol which is defined relative to the particular DL 104, for example by way of non-limiting examples Proof-Of Stake, Byzantine fault tolerance protocols, Proof-Of Work etc. The DPENs 126 communicate together, along with the other DL nodes 124, and the DPA 128 to form a peer-to-peer distributed network.

The DPENs 126 are those nodes which take part in the consensus protocol which is defined relative to the particular DL 104, for example by way of non-limiting examples Proof-Of Stake, Byzantine fault tolerance protocols, Proof-Of Work etc. The DPENs 126 communicate together, along with the other DL nodes 124, and the DPA 128 to form a peer-to-peer distributed network.

In at least one embodiment of the present disclosure, the graph nodes 114 and the DPENs 126 are the physical layer upon which the logical, software embodied modules described hereinafter reside.

The DPA 128 is arranged to receive a digital protocol dictionary from the communications unit 106 at regular intervals. The digital protocol dictionary comprises a digital protocol for execution at the DPENs 126 and additional metadata, described in detail hereinafter with reference to the communications unit 110.

The communications unit 106 comprises an integration module 130, a sensor module 132, an event storage module 134, an event regulator module 136 and a decision module 138.

The integration module 130 executes initial configuration data specifying initialisation of the nodes 112 and the initial configuration of data within the KG 112 to be stored at the nodes 112, which are communicated to the KG 112 via the nodes 114. The initialisation of the nodes 112 involves specifying, by way of non-limiting example, such characteristics as specifying communication infrastructure, communication protocols, routing service, registering the nodes 114 identity along with cryptographic keys to an identity management scheme, either public or private. Alternatively, or additionally, the integration module 130 executes initialisation of the DPENs 126. The initialisation of the DPENs 126 involves specifying, by way of non-limiting example, such characteristics as specifying communication infrastructure, communication protocols, routing service, registering the DPENs 126 identity along with cryptographic keys to an identity management scheme, either public or private.

The integration module 130 configures respective Formats such that 130 configures some parameters of the network infrastructure (for example of the DPENs 126). The integration module 130 configures respective consensus protocol weight for each DPEN 126 such that specific configurations of DPEN 126 weightings can be implemented based upon the semantics associated with each operation executed, where appropriate. For example, a specific subset of DPENs may have different weightings associated with them for a first operation than for a second operation.

The integration module 130 defines a common data format to allow data exchange between the KG 112 and the DL 104. Data stored on the DL 104 is distributed across nodes 114 which typically, but not necessarily, stored in various database types, each of which may have a unique data format. A common sematic mapping between the DL 104 and the KG 112 is defined by the integration module and is used to encapsulate data exchanged between the DL 104 and the KG 112. This establishes a logical/semantical connection between DL 104 and KG 112 to let them understand what each other is saying, it provides semantic sense to the decoded data in the previous step. By way of non-limiting example, if a user uses protobuf, and correctly populated our struct with the correct key and value pairs from a data, by reading some values inside that struct and/or using defined methods over that struct the integration module determines and maps what to do with this data, for example “update X”

The integration module 130 selects a cryptographic protocol which is compatible with those employed in both the KG 112 and the DL 104 such that data exchange between the KG 112 and the DL 104 is cryptographically secure. It will be appreciated that some or all nodes 114 of the DL 104 may be located on a physical network node, by way of non-limiting example, server, processor, as the some or all of the graph nodes 126, and where this is the case the integration module 130 will be arranged to configure the same network client to operate accordingly. In such an instance, the network client will comprise libraries and protocols enabling it to act as both node 114 and DPEN 126.

The sensor module 132 communicates directly with the DPENs 126 and are typically embodied in software. The sensor module 132 comprises sensing software routines arranged to, by way of non-limiting example, log, monitor and profile data relating to the operation of the DL 104 from the DPENs such that the software routines of the sensor module 132 can process this operational data to draw inferential information, i.e. data plus context, relating to the operational state of the execution of the digital protocol on the DL 104. For example, the sensor module 132 receives data from the DPENs 126 relating to, by way of non-limiting example, whether the status of operations, i.e. whether an operation of the digital protocol was executed successfully, failed or was rejected, the throughput and velocity of operations, operation processing latency, i.e. the length of time taken to execute a operation and for the DL 104 to achieve consensus of the result of the operation., evidence of malicious activity, for example double spending of states or blocking of the digital protocol operation. The sensor module 132 outputs the information to the event storage module 134. In the present example, the sensor module 132 monitors all events and passes them to the event storage module 134. However, it will be appreciated that one or more subsets of events can be excluded from monitoring by the sensor module 132. It will be appreciated that the sensor module 132 may be provided as a centralised software module arranged to receive data from some or all of the nodes 114, or some or all of the DPENs 126.

Alternatively, the sensor module may comprise a decentralised array of software routines each of which receive data from one or more of the nodes 114, or more particularly one of more of the DPENs 126. The sensor module 132 processes, for example, by carrying out operations such as: filtering, aggregation, selection, join, etc., the operational data and outputs them to the event storage module 134.

In one embodiment of the present invention, the event storage module 134 receives the self-aware and context aware data from the sensor module 132 and also receives a list of operations and events that are historical, currently occurring or are going to occur in the DL 104 that it should monitor, hereinafter referred to as an empty event dictionary, via the sensor module 132. The event storage module 134 typically groups the self-aware and context aware data receive from the sensor module 132 based upon, for example the type of sensor information, such as by way of non-limiting example, whether the status of operations, the throughput and velocity of operations, operation processing latency, evidence of malicious activity. The event storage module 134 collates sensor information relating to the events listed in the empty events dictionary and populates a file to be output to the event regulator 136 with respective sensor information tied to each respective event, hereinafter referred to as the populated event dictionary. The populated event dictionary is output to the event regulator 136.

The event regulator module 136 evaluates the execution of the DL 104 by querying the populated event dictionary received from the event storage module 134. The populated event dictionary comprises multiple operations and/or operation types, such as, by way of non-limiting example, execution results and statistics of tracked transactions and events, the execution status of the DL 104 such as such as event processing stats for example latency, number of processed transactions per second etc., groupings of types of events and/or transactions either within a single data structure or across data structures and their behaviours can represent a single tracked event. The event regulator module 136 receives a weight dictionary from the decision module 138, which describes the relative importance of each operation recorded on the DL 104, typically these weights are a fractional numerical weighting factor representing the likelihood of an outcome of an operation. The event regulator module 136 queries the populated event dictionary to derive details of the digital protocol in the DL 104, for example the event regulator 136 can, by way of non-limiting examples, collate execution results for all types of operations, extract details of attacks on the DL 104, failed transaction statistics and DL execution analytics such as that collected from sensor modules 132. The event regulator module 136 compares the operation weights contained in the weight dictionary to the events stored in the populated event dictionary and identifies those events which lie outside of an expected execution pattern assigned to the events associated with the operations by the KG 112, this comparison may comprise a thresholding comparison of DL execution results with the weight dictionary entries. For example the expected weighting for an event outcome in the KG 112 may be 0.9 whereas the execution result probability for that event outcome at the DPENs 126 may be 0.8 and any execution result deviating by, for example by way of non-limiting example 0.05 or alternatively one standard deviation, may be flagged as an unexpected result. The event regulator module 136 then collates those events which have unexpected execution results into an unexpected event dictionary. Typically, and by way of non-limiting example, the unexpected event dictionary is a file comprising data detailing events and operation outcomes which have been subject to scenarios unexpected within the KG 112 construct, for example a failed operation, an operation with a differing outcome than that expected, and where there is an attack on the DL system, such as an attempt to alter the digital protocol, an attack on the DL infrastructure or code, or the DPEN nodes, for example a double spend attack or locking of a node. Once the unexpected results dictionary is generated it is output to the decision module 138.

The decision module 138 acts as a generator of feedback, for example by providing feed back to the KG 112 in relation to execution of digital protocols at the DL 104 to allow the KG 112 to be updated in response the execution of digital protocols and operation on the DL 104. Additionally or alternatively, updates to the KG 112 in respect of user input data and information, and/or updates received from external information systems, are processed in order to generate and distribute digital protocols and their associated meta-data to the DPENs 126.

The decision module 138 receives the unexpected results dictionary from the event regulator module 136 and can also receive user generated input in relation to parameters and operations to be included in the digital protocol distributed to and deployed at the DPENs 126. Limiting the set of DPEN execution results to be processed at the decision module 138 to those which are unexpected reduces the computational intensiveness required for the subsequent iterative data processing.

In respect of user input and updated KG data and meta data where pre-processing is required to generate actions and operations in the appropriate digital protocol format for execution as the DL 104, the decision module 138 executes pre-processing steps which include, by way of non-limiting example can include, analysing the textual information of the input information file, for example by parsing the text to extract key operands and keywords, the operations contained or indicated in the input information file are classified and mapped to appropriate corresponding digital protocol format operations. The analysis and cross-mapping are carried out the information contents of the input information file are carried out by machine learning protocols, such as, by way of non-limiting example, natural language processing or other forms of text analytics. The result of the pre-processing is that a set of digital protocol compliant operations are generated from the non-protocol compliant information input file. In the instance where the input information file is digital protocol compliant, for example an output from the KG 112 communicated using the standard format and agreed communication protocol the pre-processing steps can be omitted.

In order to generate a digital protocol for distribution to the DPENs 126 the decision module 138 must analyse the operation and actions associated with them to identify all possible outcomes of the operations, i.e. to determine a set of all possible execution results. For example, if the operation in question is a two party swap of value tokens between first and second parties, the possible results identified by the decision module 138 may comprise the following: successful completion of the transaction in which both parties received their value tokens, only one party receives their value token, neither party receives their value tokens, or the transaction is rejected. There may be further sub-divisions within the failure of the transaction to provide more granularity to the operation status, for example the sensor module 132 may be arranged to determine the reason for the transaction failing, for example data may be returned on failure of a transaction to indicate insufficient funds held by the first party to send the value token, either the first or the second party may be unreachable on the network which can be indicated by a time out limit being reached, or that the transaction failed due to a network attack on the DL 104 or that a double spend is being attempted. It will be appreciated that although the example given hereinbefore is related to a financial transaction this is merely for the ease of understanding and the applicability of the present invention extends in to many other fields, for example autonomous driving (protocols to manage self driving cars), drones fleet management, coordination of software agents, smart cities, smart buildings, management of a cloud infrastructure could or any technical field where concerted consensus based decisions are required.

The sensor module 132 monitors traffic across the network for this type of information and data to feed into the event storage module 134 which is then passed through the event regulator module 136 to the decision module 138.

Typically, the possible execution results are verified by reference to a trained machine learning model. In the first instance the possible execution results are verified by domain experts in order to eliminate non-applicable results from the training set for the machine learning model, by way of non-limiting example, a recurrent neural network, a Deep Relational Machine, a Symbolic Deep Neural Network that takes inputs from Inductive Logic Programming algorithms.

The decision module 138 then interacts with the KG 112 to determine the location of possible execution results within the KG 112, and from that their dependencies and relationships to other possible execution results and more generally within the KG 112 entry structure. The dependencies and relationships can be expressed as metadata associated with the possible execution results. The edges of the KG 112 between nodes can be assigned weights associated with the probability of a possible execution result. The possible execution results can be weighted according to the edge weightings to produce a weighted execution result, in the previous transaction example the probability of a successful transfer of value tokens between the parties may by 0.9, the probability of only one party receiving their value token may be 0.01, and the probability of neither party not being reachable may be 0.09 and the probability of the transaction being rejected, for whatever reason, may be 0, and the corresponding results are factored in likelihood accordingly by the decision module 138. This weighted set of possible execution results, along with the actions and operations of the input information file is used to generate a revised digital protocol that is output to the DPENs 126 for execution. This is the feedback from the KG 112 to the DL104, and comprises adjusting the KG 112 in response to create updated semantics in response to the convergence of probability landscapes associated with the KG 112 and the DL 104 and the subsequent output of an updated digital protocol, based upon the parameters of the KG 122 associated with converged probability landscapes, for execution on the DPENs 126.

Following the output and execution of the revised digital protocol at the DPENs 126 the decision module 138 receives an updated unexpected event dictionary from the event regulator module 136. The decision module 138 then generates a DL probability landscape 140 based upon the actual execution statistics generated by the execution of the digital protocol at the DPENs 126 which are associated with the unexpected events. For example, in the example of a two party value exchange the execution results at the DPENs 126 may indicate a probability of the value exchange being completed successfully as 0.9. The DL probability landscape 140 generated using, by way of non-limiting example, Montecarlo modelling, artificial neural networks, Black-Scholes-Merton modelling, and will, for example, take the form of an n-dimensional hyperplane, typically but not exclusively a hypersphere. The exact form and dimensions of the hyperplane depend upon properties of the execution results at the DPENs 126.

This contrasts to a KG probability landscape 142 which is based upon an expected set of state transitions associated with the execution of the digital protocol and which is defined by expected state transitions expressed in the KG 112. The KG probability landscape 142 for these expected state transitions is typically generated in the same manner as the DL probability landscape 140. However, it will be appreciated that the example shown hereinbefore in relation to the generation of DL probability landscape 140 is exemplary only and any other technique can be employed for the generation of both or either of the DL probability landscape 140 and/or the KG probability landscape 142.

The spheres of the DL probability landscape 140 and the KG probability landscape 142 are compared using for example, vector difference analysis, gradient methods or any other norm based algorithms, although it will be appreciated by the person skilled in the art than any suitable method of comparison can be used.

This comparison of the DL and KG probability landscapes 140,142 identifies points at which the two landscapes 140, 142 diverge and computes the difference between the actual execution results at the DPENs 126 and the expected state transitions as defined in the KG 104. Typically these divergences are calculated as probability divergence vectors 144 using, for example using a generalised norm technique such as, by way of non-limiting example, Euclidian Distance, Mahattan Distance, or p-norm. It will be appreciated that the n-dimensional hyperplanes defined by the KG and DL probability landscapes 142, 140 need not be of the same dimension so both the magnitude and vector properties of the probability divergence vectors 144 need to be determined in such instances.

Where divergence is outside a boundary limit, typically more than a threshold measure across the landscapes 140, 142, alternative state transitions are modelled for those DPEN execution results which form the unexpected events dictionary. Alternatively, the divergence can be measured on a point to point basis across the curve of the probability landscapes and can therefore be defined dynamically. The alternative state transitions are modelled by varying the probability divergence vectors 144 to generate a feedback probability landscape 146. The probability divergence vectors are varied by performing operations on either or both of the KG and DL probability landscapes 140, 142 such as, by way of non-limiting example, vector addition, vector subtraction, averaging, convolution and any other such appropriate vector operation. These operations are iterated until such an end state is reached where the probability divergence vectors 144 between the feedback probability landscape 146 and the DL probability landscape 140 across the landscapes lies within a boundary limit.

From the final feedback probability landscape 146 an updated set of state transition weights are defined corresponding such that, when uploaded to the KG 112, the state transition weights of the KG 112 lie within in acceptable limit of the actual execution results of the execution of the digital protocol at the DPENs 126. Accordingly, the updated set of state transition weights are uploaded to the KG 112 such that the theoretical system state stored in KG 112 is either identical to, or lies within in acceptable statistical range of, the actual system state following execution of the digital protocol by the DPENs 126. Accordingly, using the methodology and system described hereinbefore data and information consistency between disparate information systems.

In summary, a probability landscape in the from a hyperplane in multiple dimensions that represents the probability of an event (E) to happen is computed by a Risk or probability model M. Remember that Events are the outcomes of the Digital Protocol (DP).
M(inputs, DP)=probability(E)

As there are two disparate computing systems, in the present example, the DL 104 and the KG 112, the same Model M is applied to different set of inputs:
1) KG: inputs are the weights and structure of the KG. So, the model computes a probability landscape according to the structure of the KG.
2) DL: inputs is the transactions and event history and infrastructure parameters (routing, consensus node weights etc)

Models can be any model or computational artefact that computes the probabilities of an event, such as, by way of non-limiting example, Montecarlo, Markov, analytical risk models etc.

At each iteration of the feedback system:
a) the model computes the probability landscape with the KG inputs
b) The model computes the probability landscape with the DL inputs
c) The difference between the two probability landscapes is computed;

The forward part of the feedback system begins now:
d) The difference is used to readjust the weights and the structure of the KG 112;
e) The KG produces a new Digital Protocol that is passed to M;

The backward part of the feedback system begins now:
f) The new Digital Protocol adjusts the infrastructure parameter of the DL 104 (for example, consensus weights, routing etc).

The feedback system returns to (a). If the difference is below a certain threshold, the loop is concluded.

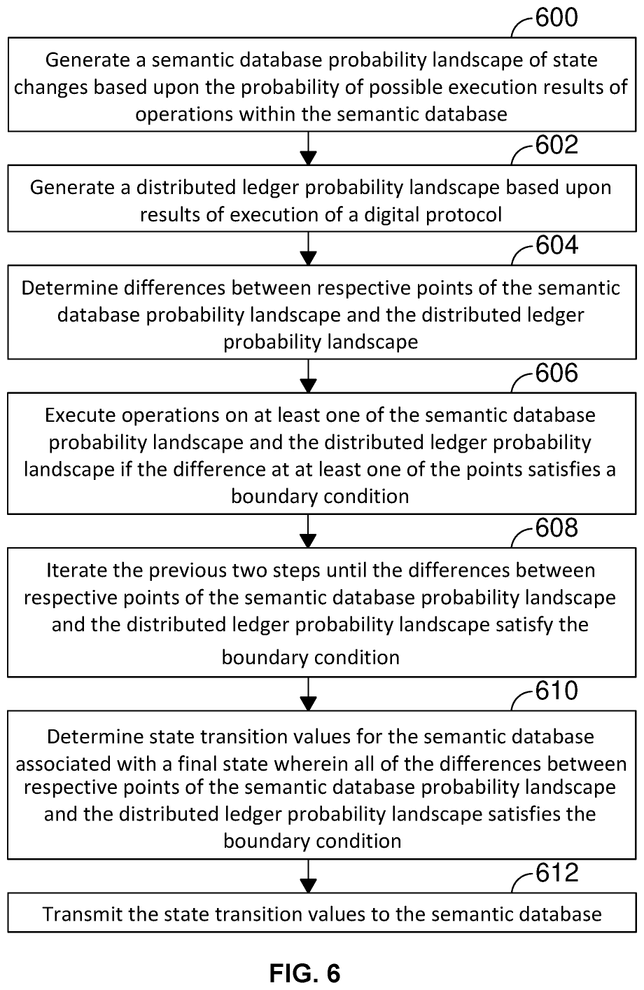

Referring now to FIG. 6, a method of communicating between a distributed ledger and a semantic database comprises generating a semantic database probability landscape of state changes based upon the probability of possible execution results of operations within the semantic database (Step 600). A distributed ledger probability landscape based upon results of execution of a digital protocol is generated (Step 602). Differences between respective points of the semantic database probability landscape and the distributed ledger probability landscape are determined (Step 604). Operations are executed on at least one of the semantic database probability landscape and the distributed ledger probability landscape if the difference at at least one of the points satisfies a boundary condition (Step 606). The determination of difference and the execution of operations on the semantic database probability landscape and the distributed ledger probability landscape are iterated until all of the differences between respective points of the semantic database probability landscape and the distributed ledger probability landscape satisfy the boundary condition (Step 608). State transition values for the semantic database associated with a final state are determined wherein all of the differences between respective points of the semantic database probability landscape and the distributed ledger probability landscape exceeds the threshold (Step 610). The state transition values are transmitted to the semantic database. (Step 612).

Either or both of the semantic database probability landscape or/and the distributed ledger probability landscape may comprise an n-dimensional hyperplane.

The difference between respective points of the semantic database probability landscape or/and the distributed ledger probability landscape may be determined using a generalised norm technique. The general norm technique may at least one of the following: Euclidian Distance, Mahattan Distance, p-norm.

The method may comprise generating possible execution results of defined operations on the semantic database.

The method may comprise generating a digital protocol comprising instructions based upon possible execution results of the operations. The method may comprise executing the digital protocol at nodes of a distributed ledger. The digital protocol may comprise a machine readable text

In general, the routines executed to implement the embodiments of the invention, whether implemented as part of an operating system or a specific application, component, program, object, module or sequence of instructions, or even a subset thereof, may be referred to herein as “computer program code,” or simply “program code.” Program code typically comprises computer readable instructions that are resident at various times in various memory and storage devices in a computer and that, when read and executed by one or more processors in a computer, cause that computer to perform the operations necessary to execute operations and/or elements embodying the various aspects of the embodiments of the invention. The computer readable program instructions for carrying out operations of the embodiments of the invention may be, for example, assembly language or either source code or object code is written in any combination of one or more programming languages.

The program code embodied in any of the applications/modules described herein is capable of being individually or collectively distributed as a program product in a variety of different forms. In particular, the program code may be distributed using the computer readable storage medium having the computer readable program instructions thereon for causing a processor to carry out aspects of the embodiments of the invention.

Computer readable storage media, which is inherently non-transitory, may include volatile and non-volatile, and removable and non-removable tangible media implemented in any method or technology for storage of information, such as computer-readable instructions, data structures, program modules, or other data. Computer readable storage media may further include RAM, ROM, erasable programmable read-only memory (EPROM), electrically erasable programmable read-only memory (EEPROM), flash memory or other robust state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. A computer-readable storage medium should not be construed as transitory signals per se (e.g., radio waves or other propagating electromagnetic waves, electromagnetic waves propagating through a transmission media such as a waveguide, or electrical signals transmitted through a wire). Computer readable program instructions may be downloaded to a computer, another type of programmable data processing apparatus, or another device from a computer readable storage medium or an external computer or external storage device via a network.

Computer readable program instructions stored in a computer readable medium may be used to direct a computer, other types of programmable data processing apparatus, or other devices to function in a particular manner, such that the instructions stored in the computer readable medium produce an article of manufacture including instructions that implement the functions/acts specified in the flowcharts, sequence diagrams, and/or block diagrams. The computer program instructions may be provided to one or more processors of a general-purpose computer, special purpose computer, or other programmable data processing apparatus to produce a machine, such that the instructions, which execute via the one or more processors, cause a series of computations to be performed to implement the functions and/or acts specified in the flowcharts, sequence diagrams, and/or block diagrams.

In certain alternative embodiments, the functions and/or acts specified in the flowcharts, sequence diagrams, and/or block diagrams may be re-ordered, processed serially, and/or processed concurrently without departing from the scope of the invention. Moreover, any of the flowcharts, sequence diagrams, and/or block diagrams may include more, or fewer blocks than those illustrated consistent with embodiments of the invention.

The terminology used herein is for the purpose of describing particular embodiments only and is not intended to be limiting of the embodiments of the invention. As used herein, the singular forms “a”, “an” and “the” are intended to include the plural forms as well, unless the context indicates otherwise. It will be further understood that the terms “comprise” and/or “comprising,” when used in this specification, specify the presence of stated features, integers, steps, operations, elements, and/or components, but do not preclude the presence or addition of one or more other features, integers, steps, operations, elements, components, and/or groups thereof. Furthermore, to the extent that the terms “includes”, “having”, “has”, “with”, “comprised of”, or variants thereof are used in either the detailed description or the claims, such terms are intended to be inclusive in a manner similar to the term “comprising”.

While a description of various embodiments has illustrated all of the inventions and while these embodiments have been described in considerable detail, it is not the intention to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the spirit or scope of the general inventive concept.

1. A computer implemented method of enhancing computational consistency between a distributed ledger and a semantic database comprising:
i) generating a semantic database probability landscape of state changes based upon the probability of possible execution results within the semantic database
ii) generating a distributed ledger probability landscape based upon results of execution of a digital protocol;
iii) determining differences between respective points of the semantic database probability landscape and the distributed ledger probability landscape;
iv) executing operations on at least one of the semantic database probability landscape and the distributed ledger probability landscape if the difference at at least one of the points fails to satisfies a boundary condition;
v) iterating steps vi) and vii) until the differences between at least one pair of respective points of the semantic database probability landscape and the distributed ledger probability landscape satisfy the boundary condition;
vi) determining state transition values for the semantic database associated with a final state wherein all of the differences between the at least one pair of respective points of the semantic database probability landscape and the distributed ledger probability landscape satisfies the boundary condition; and
vii) transmit the state transition values to the semantic database.

2. The method of claim 1 wherein the semantic database comprises a knowledge graph.

3. The method of claim 1 wherein generating the semantic database probability landscape comprises analysing a plurality of execution results of a plurality of operations, and wherein verifying the plurality of execution results of the plurality of operations or generating the semantic probability landscape comprises querying nodes of the semantic database and identifying nodes within the semantic database at which each of the plurality of execution results is located.

4. The method of claim 3 wherein generating the semantic database probability landscape comprises assigning a respective weight to the plurality of execution results based upon the node at which the plurality of execution results is located.

5. The method of claim 1, wherein generating the semantic database probability landscape comprises mapping the plurality of execution results as state changes effected by the operations and/or generating the semantic database probability landscape comprises weighting state changes using the weights assigned to the plurality of execution results.

6. The method of claim 1, further comprising assigning a probability to each of the plurality of execution results.

7. The method of claim 1, further comprising comparing execution results of the digital protocol upon the distributed ledger to a library of expected results and generating an exception list corresponding to divergences between the library of expected results and the execution results and/or generating the distributed ledger probability landscape based upon the exception list.

8. The method of claim 7 comprising excluding expected execution results from the generation of the distributed ledger probability landscape.

9. The method of claim 1, further comprising aligning respective events in the semantic database probability landscape and the distributed ledger.

10. The method of claim 1, wherein either or both of the semantic database probability landscape or/and the distributed ledger probability landscape comprises an n-dimensional hyperplane.

11. The method of claim 1, wherein determining difference between respective points of the semantic database probability landscape and the distributed ledger probability landscape comprises calculating probability difference vectors between the respective points.

12. The method of claim 1, further comprising generating a feedback probability landscape based upon the execution of operations upon either of the semantic database probability landscape or the distributed ledger probability landscape and iterating determining differences between respective points of the semantic database probability landscape and the distributed ledger probability landscape iterating steps vi) and vii) until the differences between at least one pair of points of the feedback probability landscape and the corresponding points of the semantic database probability landscape and the distributed ledger probability landscape satisfy the boundary condition.

13. The method of claim 1, wherein the difference between respective points of the semantic database probability landscape or/and the distributed ledger probability landscape is determined using a generalised norm technique.

14. The method of claim 1, further comprising generating an updated digital protocol dictionary comprising state transition values corresponding to a state where the probability difference vectors satisfy the boundary condition and/or wherein the updated digital protocol dictionary comprises metadata associated with possible execution results of operations in the updated digital protocol library.

15. The method of claim 1, further comprising generating the digital protocol comprising instructions based upon updated weights associated with possible execution results of the operations.

16. The method of claim 1, further comprising updating the semantic database in response to receiving the state transition values.

17. The method of claim 1, wherein the digital protocol comprises a machine readable text file.

18. The method of claim 1, further comprising executing the digital protocol at nodes of a distributed ledger.

19. A processor arranged to execute a method comprising:
i) generating a semantic database probability landscape of state changes based upon the probability of possible execution results within the semantic database
ii) generating a distributed ledger probability landscape based upon results of execution of a digital protocol;
iii) determining differences between respective points of the semantic database probability landscape and the distributed ledger probability landscape;
iv) executing operations on at least one of the semantic database probability landscape and the distributed ledger probability landscape if the difference at at least one of the points fails to satisfies a boundary condition;
V) iterating steps vi) and vii) until the differences between at least one pair of respective points of the semantic database probability landscape and the distributed ledger probability landscape satisfy the boundary condition;
vi) determining state transition values for the semantic database associated with a final state wherein all of the differences between the at least one pair of respective points of the semantic database probability landscape and the distributed ledger probability landscape satisfies the boundary condition; and
vii) transmit the state transition values to the semantic database.

20. A computing system comprising:
a distributed ledger comprising a plurality of nodes;
a semantic database; and
a processor arranged to operate according to claim 19.

21. A data carrier carrying software which when executed on a processor causes the processor to act as the processor of claim 19.
